(19) United States
(12) Patent Application Publication
(10) Pub. No.: US 2009/0078324 A1
(43) Pub. Date: Mar. 26, 2009

(54) GAS-PANEL SYSTEM

(75) Inventors: Hubert Dinh, Hayward, CA (US); Sowmya Krishnan, Newark, CA (US); Bruce C. Wier, Sunnyvale, CA (US); Mohamed Saleem, Fremont, CA (US)

Correspondence Address: King & Spalding LLP, P.O. Box 889, Belmont, CA, 94002-0889, US

(73) Assignee: ULTRA CLEAN TECHNOLOGY, INC., Hayward, CA (US)

(21) Appl. No.: 12/235,112

(22) Filed: Sep. 22, 2008

Related U.S. Application Data
(60) Provisional application No. 60/974,416, filed on Sep. 21, 2007.

(51) Int. Cl. F16K 31/36

(52) U.S. Cl. 137/487.5

(57) ABSTRACT

The invention involves the introduction of a gas-flow restrictor and reservoir upstream of a mass flow controller (MFC) in a gas-panel stick. The restrictor and reservoir components function to smooth out pressure spikes in the gas line, thus preventing gas-flow irregularities that can occur in an MFC or pressure-insensitive MFC. The restrictor and reservoir components can be integrated into the MFC.

This patent application claims priority to U.S. Provisional Patent Application No. 60/974,416 filed on Sep. 21, 2007, which is incorporated herein in its entirety by reference.

### FIELD OF THE INVENTION

The present invention relates to an improved gas panel in which process-gas pressure spikes, e.g., due to changing the condition of a valve in the gas panel, are substantially moderated.

### BACKGROUND OF THE INVENTION

Advanced microelectronic devices are being manufactured with ever increasing device density and complexity. The device dimensions are decreasing in both the lateral and vertical directions. Smaller device elements allow for increasingly complex, faster, and more powerful devices. The multitude of layers and materials used in the construction of these advanced devices are being deposited by a number of well known techniques comprising low pressure thermal chemical vapor deposition (LPCVD), plasma enhanced chemical vapor deposition (PECVD), atmospheric pressure chemical vapor deposition (APCVD), physical vapor deposition (PVD), thermal conversion of the substrate, and the like. Additionally, other well known techniques comprising etch, chemical mechanical polishing (CMP), ion implantation, electroplating, photoresist processing, and the like have also seen rapid development. Each of these techniques involves the controlled delivery of various chemical species in either a liquid or gaseous state to the substrate to facilitate the practice of the specific process method. Examples of suitable substrates comprise silicon wafers, gallium arsenide wafers, glass substrates as used in the manufacture of flat panel displays, “thin film head” substrates as used to manufacture memory disk drives for computers, substrates used in the manufacture of photonic devices, substrates used in the manufacture of micro-electro-mechanical systems (MEMS) devices, polymeric substrates as might be used for organic-based devices, and the like.

The processing gases supplied in the above microfabrication methods are typically supplied by one or more gas sticks, each containing a plurality of gas components that are manifolded together for gas flow in an upstream to downstream direction through each stick, and in cross-flow directions among adjacent sticks. A gas stick will typically include, in an upstream-to-downstream direction, a gas valve, gas filter, mass flow controller, and one or more additional downstream valve components. The output gas at the downstream end of the stick, in turn, may be mixed with process gas from adjacent sticks, and supplied to a processing station.

In order to carefully regulate the relative amounts of gas supplied through each stick, it is important to regulate the flow rate of gas though each stick, which means, in part, minimizing the effects of gas-pressure fluctuations in the stick. Such fluctuations can occur, for example, when valves in the stick are turned on or off, causing rapid spikes in gas pressure, typically over a time of about 100 msec, and involving pressure changes of up to 40 psi/sec.

This problem has been addressed previously by the introduction of a thermal-based pressure-insensitive gas flow controller, or PIMFC. Although this device functions to respond to and attempt to even out pressure fluctuations in the gas stick, it performs most reliable when fluctuations are fairly slow, e.g., 1 sec or more, and limited in extent, e.g., less than about 1-2 psi/sec.

Therefore, a need exists in the art for an improved gas-panel system that is capable of responding to gas-pressure fluctuations that occur over short time periods, e.g., 100 msec, and/or involve pressure changes of greater than about 1-5 psi/sec.

### SUMMARY OF THE INVENTION

The invention includes an improvement in a gas stick having, in an upstream-to-downstream direction, a gas-inlet line which receives gas from a gas source, a mass flow controller connected to the gas-inlet line for receiving gas therefrom and which functions to control the rate of gas flow through the stick, and a gas-outlet line connected to the mass flow controller for receiving output gas therefrom. The improvement includes a gas-flow restrictor placed in the gas-inlet line for restricting the rate of gas flow through the gas-inlet line to a rate substantially less than that of the gas-inlet line itself, in the absence of the restrictor, and a gas reservoir placed in the gas-inlet line, between said restrictor and the mass flow controller, for holding a volume of gas that substantially greater than the volume provided by the gas-inlet tube itself between the restrictor and mass flow controller in the absence of the reservoir. The flow-restrictor and reservoir act to substantially reduce or eliminate gas-pressure fluctuations observed in the gas-outlet line due to fluctuations in the gas-inlet line, upstream of the mass flow controller.

Where the mass-flow controller may be set to a selected set point for gas flow rate, the gas-flow restrictor may be designed to permit a gas flow rate through the gas-inlet line that is at least as great as the set point. For example, the gas-flow restrictor may restrict gas flow through the gas-inlet line to a selected flow rate between 5 and 500 standard cubic centimeter per minute (sccm). The gas gas-flow restrictor may have an orifice size of between 25-30 mils. The gas-flow reservoir may have a selected volume of between about 5-50 cubic centimeters (cc), e.g., between 10-20 cc.

The improvement having a gas-flow restrictor with an orifice size between 25-30 mils, and a gas flow reservoir with a volume between 10-20 cc is effective to substantially eliminate pressure fluctuations observed at the gas-outlet line in response to gas fluctuations of between 20-25 psi in the gas-inlet line, upstream of the gas-flow restrictor, where the mass flow controller is set to a selected set point between 20 and 100 sccm.

The mass flow controller in the stick may be a pressure-insensitive mass flow controller. The stick may also include a filter and valve in the gas-inlet line for filtering and valving gas from the source, upstream of the gas-flow restrictor.

The restrictor and reservoir may be independent gas components placed individually in the gas-panel stick, upstream of the MFC, or may be combined into a single gas component, or may be integrated into the MFC, upstream of gas-flow components of the MFC, e.g., a PIMFC.

The restrictor and reservoir may replace a conventional regulator and transducer placed in the gas-panel stick, upstream of the MFC.

The restrictor and reservoir may replace a conventional regulator and transducer placed in the gas-panel stick, upstream of the MFC.

In another aspect, the invention includes a mass flow controller comprising, in an upstream-to-downstream direction, an inlet adapted to be connected to a gas-inlet line, a gas-flow restrictor, a gas reservoir, a mass flow sensor, a proportional control valve, and a closed loop control system that functions to compare the value from the mass flow sensor and adjust the proportional control valve accordingly to achieve the required flow, wherein the flow-restrictor and reservoir act to substantially reduce or eliminate gas-pressure fluctuations observed at the proportional control valve due to fluctuations in the gas-inlet line.

These and other advantages are achieved in accordance with the present invention as described in detail below.

### BRIEF DESCRIPTION OF THE DRAWINGS

FIG. 1 shows a diagrammatic view of a portion of a gas panel stick having gas-flow restrictor and reservoir components for smoothing our pressure fluctuations seen by a mass flow controller in the stick, in accordance with the present invention;

FIGS. 2A, 3A, and 4A each show the pressure input measured at two points along the input side of a pressure-insensitive mass-flow controller (PIMFC) (top two pressure profiles in each figure), as pressure fluctuations are applied to the panel, and the DUT (measured electronic) output of the PIMFC, and the LFE (actual) output (two bottom pressure profiles in the figure); and

FIGS. 2B, 3B, and 4B each show the pressure input measured at upstream and downstream sides of a flow restrictor at the input side of a pressure-insensitive mass-flow controller (PIMFC) (top two pressure profiles in each figure), as pressure fluctuations are applied to the panel, and the DUT (measured electronic) output of the PIMFC, and the LFE (actual) output (two bottom pressure profiles in the figure).

### DETAILED DESCRIPTION OF THE INVENTION

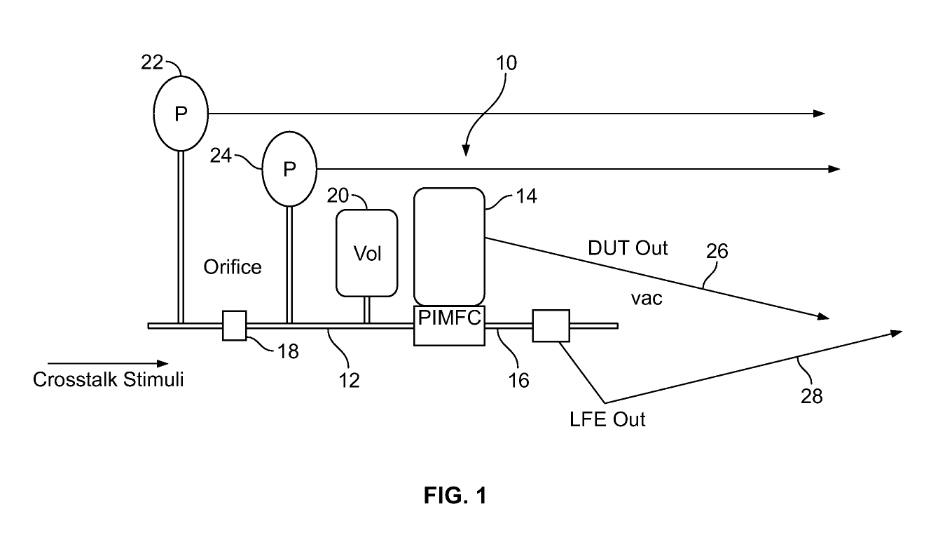

FIG. 1 shows portions of a gas-panel stick, illustrated diagrammatically at 10, for a processing gas in a gas-panel assembly. The stick generally includes, in an upstream-to-downstream direction, a gas-inlet line 12, a mass flow controller 14 connected to the gas-inlet line for receiving gas therefrom, and which functions to control the rate of gas flow through the stick, and a gas-outlet line 16 connected to the mass flow controller for receiving output gas therefrom. One preferred type of mass-flow controller (MFC) is a pressure insensitive mass flow controller (PIMFC).

The improvement of the invention includes a gas-flow restrictor 18 placed in the gas-inlet line for restricting the rate of gas flow through the gas-inlet line to a rate substantially less than that of the gas-inlet line itself, in the absence of the restrictor, and a gas reservoir 20 placed in the gas-inlet line, between the restrictor and the mass flow controller, for holding a volume of gas that substantially greater than the volume provided by the gas-inlet tube itself between the restrictor and mass flow controller in the absence of the reservoir.

In operation, the gas-inlet line is conventionally connected to a source of processing or purge gas, and may also include a filter and/or control valve for valving the entry of gas into the stick from the gas source. Both of these components are conventional, and typically located upstream of the gas-flow restrictor and gas reservoir components. The gas-outlet line may be connected to a gas mixer for mixing process gasses from two or more sticks and/or may be operatively connected to a processing station, where the process gas (alone or in a process-gas mixture), is directed onto a workpiece, such as a silicon chip. The components of the stick are typically mounted on a manifold support, according to well-known gas-panel manifolds, e.g., by mounting on the upper surface of a manifold support block.

As will be seen below, the gas-flow restrictor and reservoir act to substantially reduce or eliminate gas-pressure fluctuations observed in the gas-outlet line due to fluctuations in the gas-inlet line, upstream of the gas-flow restrictor. These fluctuations may be due, for example, to fluctuations in gas pressure at the gas source or to fluctuations caused by the control valve being switched on or off. The fluctuations typically occur over a period of about 100 msec or less and involve pressure fluctuations of at least about 5 psi. The more constant gas flow at the gas-outlet side of the stick, in turn, reduces variations in gas volume at the workpiece being processed, and thus enhances uniformity in the properties of the finished microfabricated product.

The flow restrictor typically takes the form of a narrow-bore orifice formed, for example, by laser drilling an opening in a gasket or seal used in the gas-flow line, according to conventional methods. The orifice size is selected to restrict gas flow through the restrictor to preferably between about 5-500 sccm (standard cubic centimeters per minute). In one exemplary embodiment, the flow restrictor in the embodiment shown has an orifice size of between 15-20 mils, e.g., 27 mils (thousandth of an inch).

The reservoir in the improvement is simply a defined-volume flow element which serves as a buffer in the system, functioning with the restrictor to smooth out fluctuations in line pressure. The volume of the reservoir is preferably between about 1-100 cc (cubic centimeters), preferably about 5-50 cc. In one exemplary embodiment, the reservoir has a defined volume of 10-20 cc, e.g., 15 cc (cubic centimeters). It will be appreciated that reservoir volumes will generally be dictated by restrictor flow orifice size, larger orifice sizes generally requiring larger reservoir volumes.

Although the gas-flow restrictor and reservoir can be formed as separate components located in line upstream of the mass flow controller in the stick, it will be appreciated that the restrictor and reservoir can be integrated into the mass flow controller, between the inlet port of the MFC and the flow-control components of the MFC, which conventionally include a mass flow sensor, a proportional control valve, and a closed loop control system that functions to compare the value from the mass flow sensor and adjust the proportional control valve accordingly to achieve the required flow.

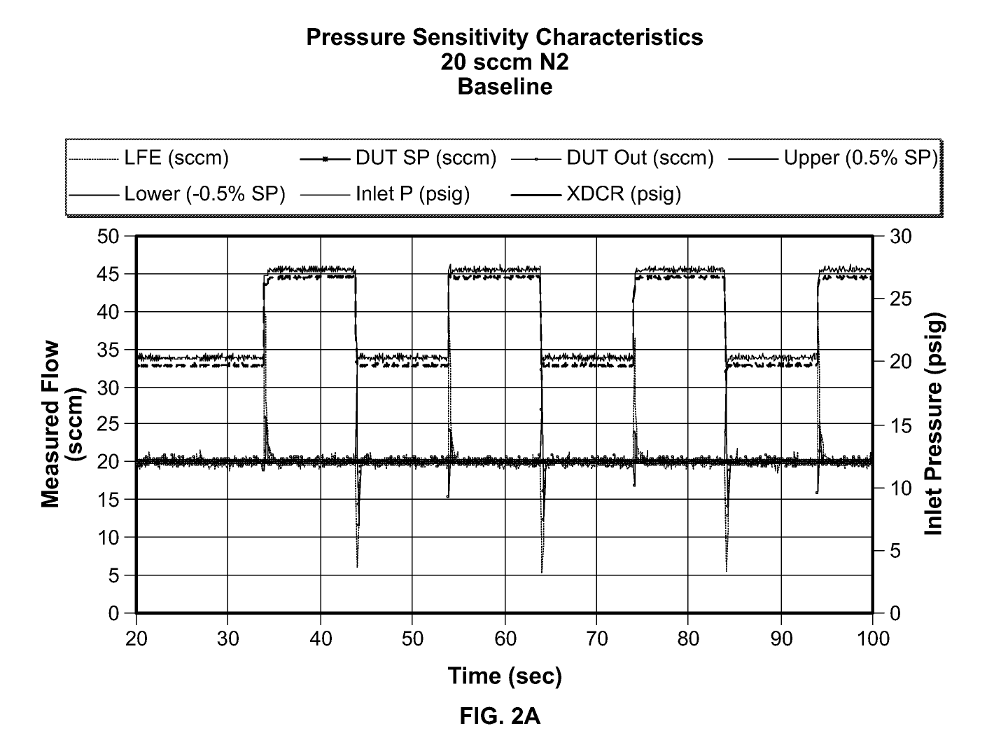

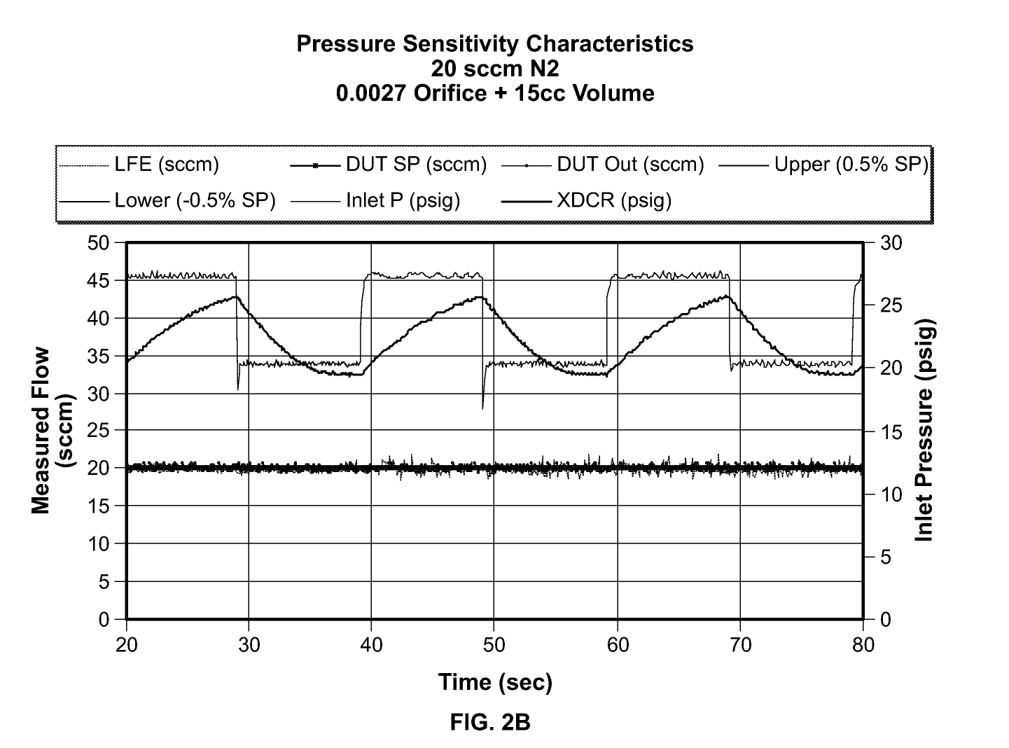

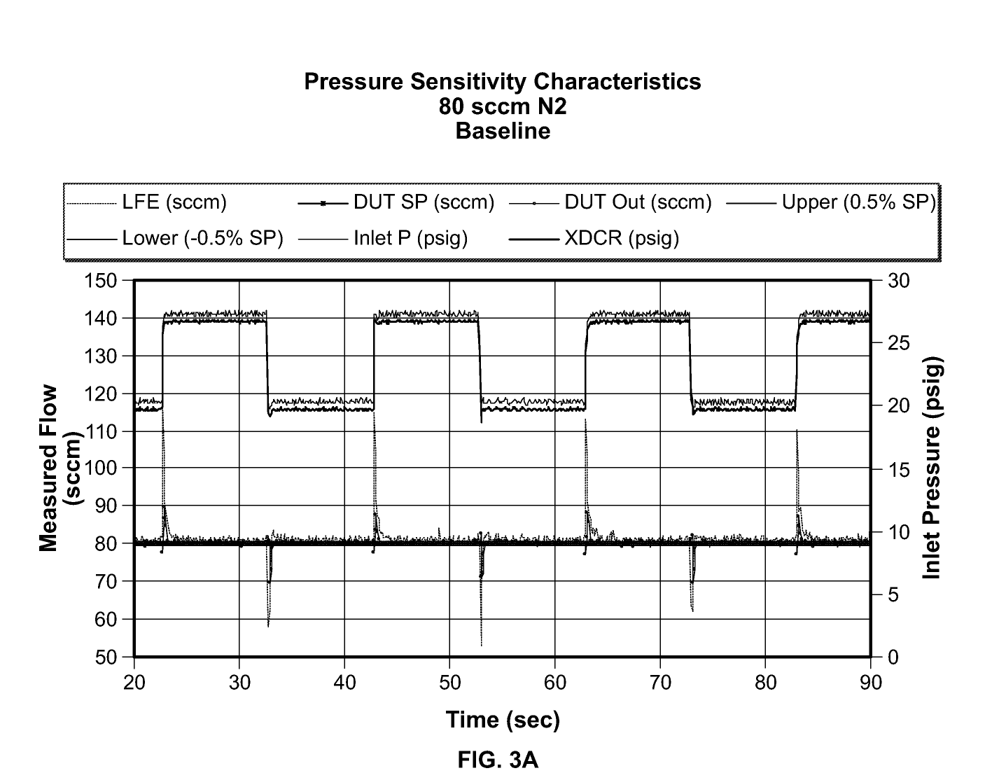

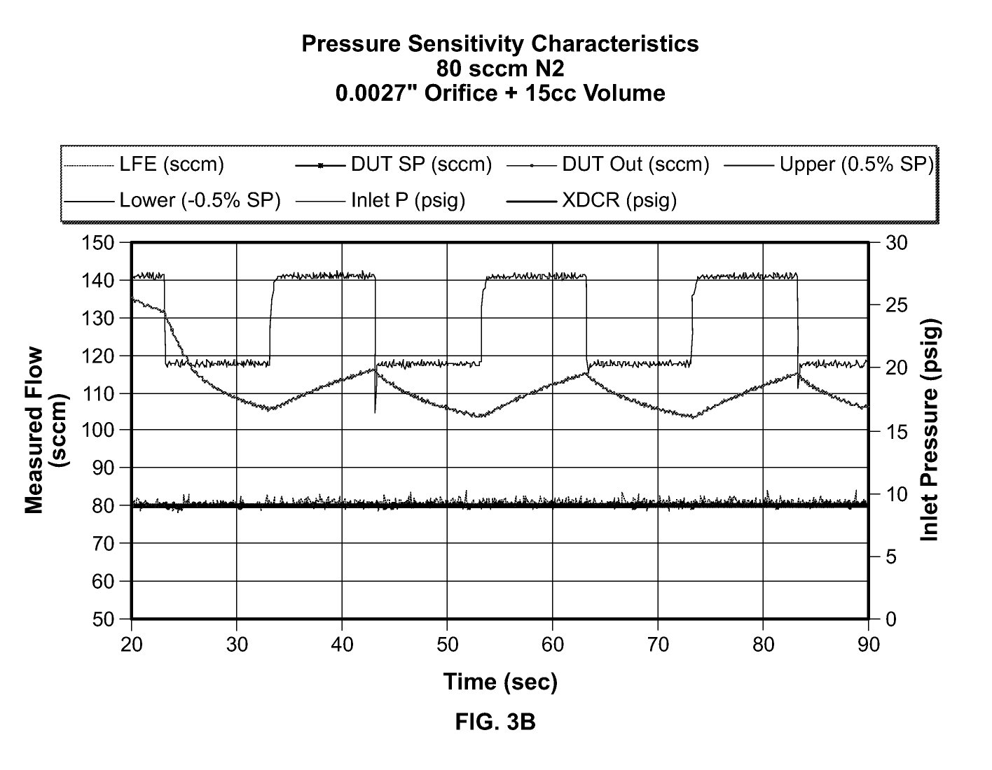

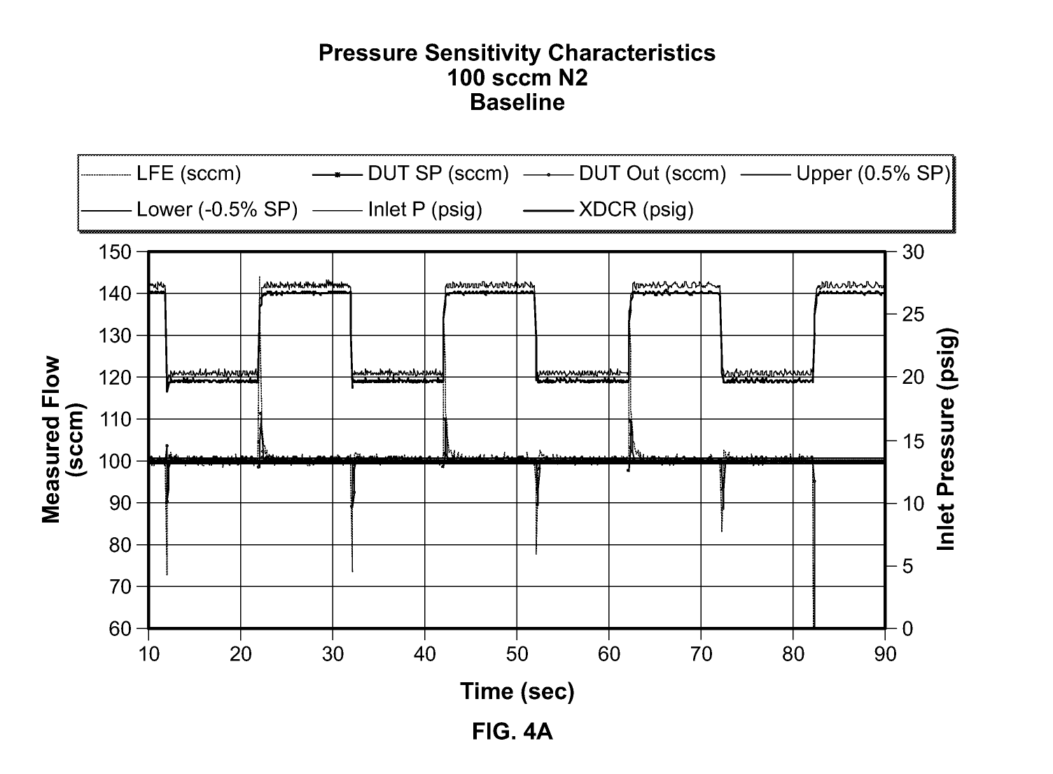

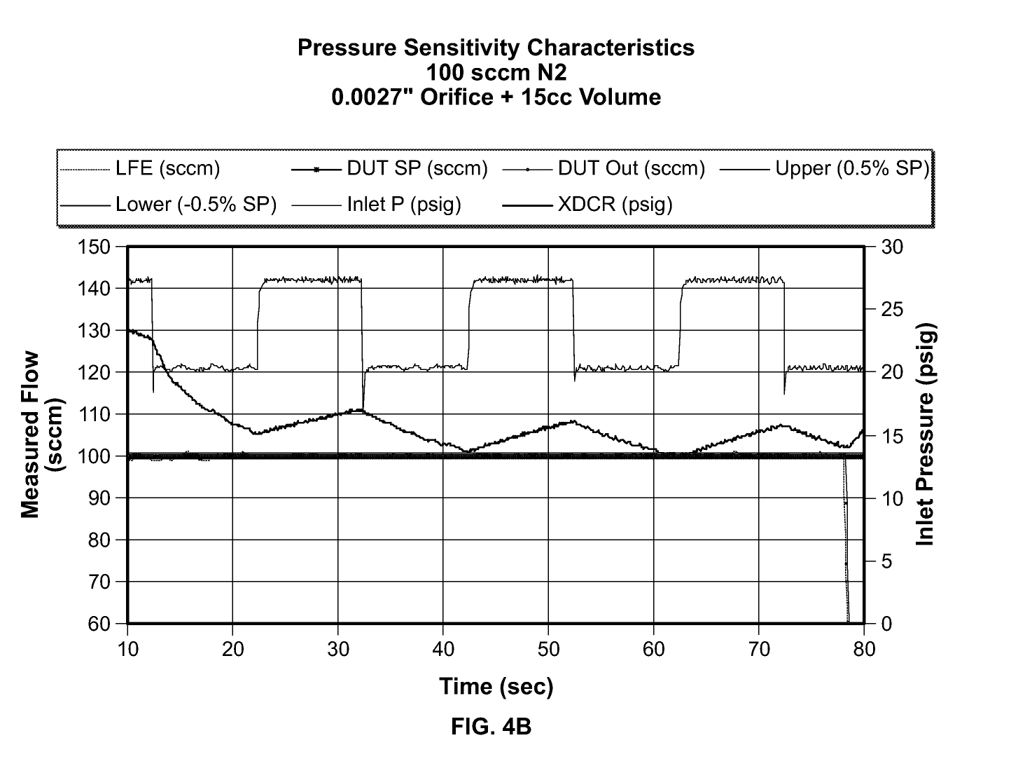

Gas flow characteristics in a gas-panel stick of the type just described are shown in FIG. 2A (without the restrictor and reservoir) and FIG. 2B (with the restrictor and reservoir). In both figures, and in comparable FIGS. 3A and 3B, and 4A and 4B, respectively, the two upper lines in the plot show pressure fluctuations on either side of the gas-flow restrictor, indicated at points 22, 24 in FIG. 1, where a restrictor is present (FIG. 2B, 3B, 3B), or are the same pressure measurements in the absence of the restrictor (FIGS. 2A, 2B, and 2C). The two output flow curves in all six plots are DUT out, the measured electronic output from the stick, and shown at 26 in FIG. 1, and LFE out, the actual measured flow, and shown at 28 in FIG. 1.

FIGS. 2A and 2B show the input and output pressure profiles in the FIG. 1 stick where the PIMFC is set to a 20 sccm set point, the gas-flow restrictor has a 27 mil orifice, and the reservoir has a 15 c volume. As seen in FIG. 2A (no restrictor and reservoir), fluctuations in gas pressure between 20-25 psig (pounds per square inch gauge) produced sharp positive and negative spikes in the measured gas-flow output. By contrast, and with reference to FIG. 2B, the orifice is seen as moderating the time-dependence of the pressure spike changes, and in combination with the reservoir, producing a substantially smooth (uniform) gas-flow output from the PIMFC.

Similar results were obtained when the PIMFC in the system was adjusted to a set point of 80 sccm, using the same restrictor and reservoir (0.0027″ orifice size and 15 cc volume, respectively), as seen in FIG. 3A and 3B. Specifically, the 20-25 psig pressure fluctuations applied to the input of the gas-panel stick produced sharp pressure spikes in the gas-flow output, in the absence of the restrictor and reservoir elements (FIG. 3A), but a substantially smooth (uniform) output in the presence of the flow-restrictor and reservoir components of the invention (FIG. 3B).

Similar results were obtained when the PIMFC was adjusted to a set point of 100 sccm, using the same restrictor and reservoir (0.0027″ orifice size and 15 cc volume, respectively), as seen in FIGS. 4A and 4B. Specifically, the 20-25 psi pressure fluctuations applied to the input of the gas-panel stick produced sharp pressure spikes in the gas-flow output, in the absence of the restrictor and reservoir elements (FIG. 4A), but a substantially smooth (uniform) output in the presence of the two improvement components of the invention (FIG. 4B).

The flow-restrictor and reservoir components of the present invention are shown in FIG. 1 as individual in-line components in the gas-panel stick configurations described above. It will be appreciated that the two components may be integrated into a single gas component, where the restrictor directly feeds into the component reservoir.

Alternatively, the two components may be integrated into an MFC, e.g., PIMFC, by including the components within an MFC housing, upstream of the flow elements in the MFC. This MFC constructed in accordance with the invention includes in an upstream-to-downstream direction, an inlet adapted to be connected to a gas-inlet line, a gas-flow restrictor, a gas reservoir, a mass flow sensor, a proportional control valve, and a closed loop control system that functions to compare the value from the mass flow sensor and adjust the proportional control valve accordingly to achieve the required flow. The restrictor and reservoir components in the MFC act to substantially reduce or eliminate gas-pressure fluctuations observed at the proportional control valve due to fluctuations in the gas-inlet line.

Although the invention has been described with reference to particular embodiments, it will be appreciated that various changes may be made without departing from the invention.

It is claimed:

1. In a gas stick having, in an upstream-to-downstream direction, a gas-inlet line which receives gas from a gas source, a mass-flow controller connected to the gas-inlet line for receiving gas therefrom and which functions to control the rate of gas flow through the stick, and a gas-outlet line connected to the mass flow controller for receiving gas therefrom, an improvement comprising
a gas-flow restrictor placed in the gas-inlet line for restricting the rate of gas flow through the gas-inlet line to a rate substantially less than that of the gas-inlet line itself, in the absence of the restrictor, and
a gas reservoir placed in the gas-inlet line, between said restrictor and the mass flow controller, for holding a volume of gas that substantially greater than the volume provided by the gas-inlet tube itself between the restrictor and mass flow controller in the absence of the reservoir,
wherein the flow-restrictor and reservoir act to substantially reduce or eliminate gas-pressure fluctuations observed in the gas-outlet line due to fluctuations in the gas-inlet line, upstream of the gas-flow restrictor.

2. The improvement of claim 1, wherein the mass flow controller can be set to a selected set point for gas flow rate, and the gas-flow restrictor permits a gas flow rate through the gas-inlet line that is at least as great as the set point.

3. The improvement of claim 2, wherein the gas-flow restrictor restricts gas flow through the gas-inlet line to a selected flow rate between 5 and 500 standard cubic centimeter per minute (sccm).

4. The improvement of claim 3, wherein the gas-flow restrictor has an orifice size of between 25-30 mils.

5. The improvement of claim 1, wherein the gas-flow reservoir has a selected volume of between about 5-50 cubic centimeters (cc).

6. The improvement of claim 5, wherein the volume of the reservoir is between 10-20 cc.

7. The improvement of claim 6, which is effective to substantially eliminate pressure fluctuations observed in the gas-outlet line in response to gas fluctuations of between 20-25 psi in the gas-inlet line, upstream of the gas-flow restrictor, where the mass flow controller is set to a selected set point between 20 and 100 sccm.

8. The improvement of claim 6, wherein the gas-flow restrictor has an orifice size of between 25-30 mils.

9. The improvement of claim 1, wherein the mass flow controller in the stick is a pressure-insensitive mass flow controller.

10. The improvement of claim 1, wherein the stick also includes and filter and valve in the gas-inlet line for filtering and valving gas from the source, upstream of the restrictor.

11. The improvement of claim 1, wherein the gas-flow restrictor and reservoir are integrated into the mass flow controller, upstream of standard gas-flow components of the controller.

12. The improvement of claim 1, wherein the wherein the flow-restrictor and reservoir act to substantially reduce or eliminate gas-pressure fluctuations observed in the gas-outlet line that occur over time periods of about 100 msec or less and/or involve pressure changes of greater than about 5 psi/sec.

13. A mass flow controller comprising, in an upstream-to-downstream direction, an inlet adapted to be connected to a gas-inlet line, a gas-flow restrictor, a gas reservoir, a mass flow sensor, a proportional control valve, and a closed loop control system that functions to compare the value from the mass flow sensor and adjust the proportional control valve accordingly to achieve the required flow, wherein the flow-restrictor and reservoir act to substantially reduce or eliminate gas-pressure fluctuations observed at the proportional control valve due to fluctuations in the gas-inlet line.

14. The mass flow controller of claim 13, wherein the gas-flow restrictor restricts gas flow to a selected flow rate between 5 and 500 standard cubic centimeter per minute (sccm).

15. The mass flow controller of claim 13, wherein the gas-flow restrictor has an orifice size of between 25-30 mils.
